(19) United States
(12) Patent Application Publication
(10) Pub. No.: US 2025/0370823 A1
(43) Pub. Date: Dec. 4, 2025

(54) POLLER WITH SHARED RECEIVE QUEUES AND CPU GROUPS FOR STORAGE CLUSTER

(71) Applicant: Dell Products L.P., Round Rock, TX (US)

(72) Inventors: Yuri Chernyavsky Derfel, Waltham, MA (US); Vladimir Shveidel, Pardes Hana-Karkur (IL); Eldad Zinger, Raanana (IL)

(21) Appl. No.: 18/732,715

(22) Filed: Jun. 4, 2024

(51) Int. Cl. G06F 9/50; G06F 9/54

(52) U.S. Cl. CPC G06F 9/5083; G06F 9/544

(57) ABSTRACT

Techniques for dynamically changing groups of CPU cores for polling shared receive queues, providing a tradeoff between decreasing latency and increasing throughput of storage nodes using RPC messaging. The techniques include, upon initialization of a storage node, assigning all its CPU cores to the same core group. The techniques include, in response to detecting that its system load has been maintained above a threshold value for a specified time interval, increasing the number of core groups by a predetermined factor, and decreasing the number of cores assigned to each core group by the predetermined factor. The techniques include, in response to detecting that the system load has been maintained at a level less than the threshold value for the specified time interval, decreasing the total number of core groups by the predetermined factor, and increasing the total number of cores assigned to each core group by the predetermined factor.

### BACKGROUND

Distributed storage systems (“clustered storage systems” or “storage clusters”) employ various techniques to distribute and maintain data among multiple storage processors (“storage nodes”). The storage nodes are typically coupled to arrays of storage devices, such as solid state drives (SSDs) and/or hard disk drives (HDDs). The storage nodes receive and service storage input/output (IO) requests (e.g., write IO requests, read IO requests) from storage client computers (“storage clients”), which send the storage IO requests to the storage nodes over one or more networks. The storage IO requests specify data blocks, data pages, data files, or other data elements to be written to or read from volumes (VOLs), logical units (LUs), filesystems, or other storage objects maintained on the storage devices. Storage nodes of a storage cluster may communicate with other storage nodes of the storage cluster using remote procedure call (RPC) messaging. Each storage node may periodically poll for receipt of an RPC request message (“RPC request”) from another storage node, process the RPC request, generate an RPC reply message (“RPC reply”), and send the RPC reply to the other storage node, which may periodically poll for receipt of the RPC reply.

### SUMMARY

Storage nodes of a storage cluster can include processing circuitries that incorporate multi-core central processing units (CPUs). To avoid contention among multiple CPU cores (“cores”) and increase throughput during RPC messaging, each RPC request/reply can be made to associate with specific corresponding cores (e.g., cores “1”, cores “2”, or cores “3”, and so on) of the storage nodes, each of which can fully process an RPC request/reply. This approach can have drawbacks, however, if core processing loads are asymmetric, such as when some cores of a storage node have high processing loads, while other cores of the storage node have lower processing loads. In this case, the processing of RPC requests/replies by the highly loaded cores can be delayed, increasing latency. Moreover, the processing circuitries of the storage nodes can incorporate different numbers of cores, which can limit the total number of cores available to process the RPC requests/replies. Such drawbacks can be addressed by using a shared queue on each storage node to receive RPC requests/replies. In this alternative approach, each core of a storage node can periodically poll a shared queue for a received RPC request/reply, and the first core to poll the shared queue can be assigned to fully process the RPC request/reply, whether or not the RPC request/reply was generated by a specific corresponding core on another storage node. This alternative approach can also have drawbacks, however, because it introduces resource sharing, which can cause contention among the cores. Moreover, scalability can be an issue as the total number of cores available for use in RPC messaging increases over time.

Techniques are disclosed herein for dynamically changing groups of CPU cores for polling shared receive queues (SRQs), providing a tradeoff between decreasing latency and increasing throughput of storage nodes using RPC messaging. In the disclosed techniques, a storage cluster can include a plurality of storage nodes, which can communicate with each other using RPC messaging. Each storage node can include processing circuitry that incorporates a multi-core CPU. Each storage node can be configured to assign each core of its multi-core CPU to a respective core group, and to allocate an SRQ for the respective core group. Each SRQ can be configured to receive RPC requests/replies generated in the course of RPC messaging. In one embodiment, each storage node can include a multi-core CPU, in which some of its cores (“poller cores”) are highly available to poll an SRQ for RPC requests/replies. In this embodiment, the disclosed techniques can include implementing a fixed number of core groups equal to the number of poller cores of the multi-core CPU, and assigning cores of the multi-core CPU to the core groups such that each core group includes one of the poller cores. Because each core group is provided with a poller core that is highly available for polling an SRQ, delays in processing RPC requests/replies can be reduced, decreasing latency.

In another embodiment, each storage node can dynamically change a number of core groups, as well as a number of cores assigned to each core group, based on updatable threshold values of the storage node's system load. In this embodiment, the disclosed techniques can include, in response to initialization of the storage node (e.g., when the system load is low), assigning all cores of its multi-core CPU to the same single core group, decreasing latency. The disclosed techniques can include allocating an SRQ for the single core group. The disclosed techniques can include, in response to detecting that the system load has increased and been maintained above a threshold value for a predetermined time interval, increasing the number of core groups by a predetermined factor (e.g., 2), and decreasing the number of cores assigned to each core group by the predetermined factor (e.g., 2), increasing throughput. The disclosed techniques can include allocating an SRQ for each of the increased number of core groups. The disclosed techniques can include, in response to detecting that the system load has decreased and been maintained below the threshold value for the predetermined time interval, decreasing the number of core groups by the predetermined factor (e.g., 2), increasing the number of cores assigned to each core group by the predetermined factor (e.g., 2), and allocating an SRQ for each of the decreased number of core groups. By dynamically changing, in runtime, the number of core groups and the number of cores assigned to each core group based on system runtime load statistics (e.g., IO load, IO pattern, usage pattern), an optimal tradeoff between decreasing latency and increasing throughput (as the number of cores available to poll each SRQ is increased/decreased) can be achieved.

In certain embodiments, a method includes monitoring a system load of a storage node. The storage node includes a multi-core central processing unit (CPU) having multiple CPU cores grouped for polling at least one shared queue for received messages. The method incudes detecting a level of the system load relative to a threshold value, and, in response to the detected level of the system load, dynamically changing a number of groups of CPU cores, and dynamically changing a number of CPU cores in each group.

In certain arrangements, the method includes, upon initialization of the storage node, assigning all the CPU cores to a single group, allocating a single shared queue for the single group, and polling, by the CPU cores assigned to the single group, the single shared queue for received messages.

In certain arrangements, the method includes detecting that the system load has increased relative to the threshold value, increasing the number of groups by a predetermined factor, and decreasing the number of CPU cores in each group by the predetermined factor.

In certain arrangements, the method includes assigning the decreased number of CPU cores to each of the increased number of groups, allocating a plurality of shared queues for the increased number of groups, respectively, and polling the plurality of shared queues for received messages by the decreased number of CPU cores assigned to the increased number of groups, respectively.

In certain arrangements, the method includes detecting that the system load has decreased relative to the threshold value, decreasing the number of groups by the predetermined factor, and increasing the number of CPU cores in each group by the predetermined factor.

In certain arrangements, the method includes assigning the increased number of CPU cores to each of the decreased number of groups, allocating a decreased plurality of shared queues for the decreased number of groups, respectively, and polling the decreased plurality of shared queues for received messages by the increased number of CPU cores assigned to the decreased number of groups, respectively.

In certain arrangements, the method includes performing one or more of assigning CPU cores that share a cache level to the same group, assigning CPU cores that execute similar application threads to the same group, assigning CPU cores that utilize resources local to a NUMA (non-uniform memory access) node to the same group, assigning a CPU core with a high average queue polling frequency to each group, and assigning a low-stressed CPU core to each group that includes a high-stressed CPU core.

In certain arrangements, the multiple CPU cores are grouped for polling the at least one shared queue for received remote procedure call (RPC) messages. The method includes polling, by the number of groups of CPU cores, the at least one shared queue for an RPC request message from another storage node, processing the RPC request message, generating an RPC reply message, and sending the RPC reply message to the other storage node.

In certain arrangements, the method includes detecting that the system load has increased relative to the threshold value, increasing the number of groups by a predetermined factor, and decreasing the number of CPU cores in each group by the predetermined factor.

In certain arrangements, the method includes detecting that the system load has decreased relative to the threshold value, decreasing the number of groups by a predetermined factor, and increasing the number of CPU cores in each group by the predetermined factor.

In certain embodiments, a system includes a memory, and processing circuitry configured to execute program instructions out of the memory to monitor a system load of a storage node. The storage node includes a multi-core central processing unit (CPU) having multiple CPU cores grouped for polling at least one shared queue for received messages. The processing circuitry is configured to execute the program instructions out of the memory to detect a level of the system load relative to a threshold value, and, in response to the detected level of the system load, to dynamically change a number of groups of CPU cores, and to dynamically change a number of CPU cores in each group.

In certain arrangements, the processing circuitry is configured to execute the program instructions out of the memory, upon initialization of the storage node, to assign all the CPU cores to a single group, to allocate a single shared queue for the single group, and to poll, by the CPU cores assigned to the single group, the single shared queue for received messages.

In certain arrangements, the processing circuitry is configured to execute the program instructions out of the memory to detect that the system load has increased relative to the threshold value, to increase the number of groups by a predetermined factor, and to decrease the number of CPU cores in each group by the predetermined factor.

In certain arrangements, the processing circuitry is configured to execute the program instructions out of the memory to assign the decreased number of CPU cores to each of the increased number of groups, to allocate a plurality of shared queues for the increased number of groups, respectively, and to poll the plurality of shared queues for received messages by the decreased number of CPU cores assigned to the increased number of groups, respectively.

In certain arrangements, the processing circuitry is configured to execute the program instructions out of the memory to detect that the system load has decreased relative to the threshold value, to decrease the number of groups by the predetermined factor, and to increase the number of CPU cores in each group by the predetermined factor.

In certain arrangements, the processing circuitry is configured to execute the program instructions out of the memory to assign the increased number of CPU cores to each of the decreased number of groups, to allocate a decreased plurality of shared queues for the decreased number of groups, respectively, and to poll the decreased plurality of shared queues for received messages by the increased number of CPU cores assigned to the decreased number of groups, respectively.

In certain arrangements, the multiple CPU cores are grouped for polling the at least one shared queue for received remote procedure call (RPC) messages. The processing circuitry is configured to execute the program instructions out of the memory to poll, by the number of groups of CPU cores, the at least one shared queue for an RPC request message from another storage node, to process the RPC request message, to generate an RPC reply message, and to send the RPC reply message to the other storage node.

In certain embodiments, a computer program product includes a set of non-transitory, computer-readable media having instructions that, when executed by processing circuitry, cause the processing circuitry to perform a method including monitoring a system load of a storage node. The storage node includes a multi-core central processing unit (CPU) having multiple CPU cores grouped for polling at least one shared queue for received messages. The method includes detecting a level of the system load relative to a threshold value, and, in response to the detected level of the system load, dynamically changing a number of groups of CPU cores, and dynamically changing a number of CPU cores in each group.

Other features, functions, and aspects of the present disclosure will be evident from the Detailed Description that follows.

### BRIEF DESCRIPTION OF THE DRAWINGS

The foregoing and other objects, features, and advantages will be apparent from the following description of particular embodiments of the present disclosure, as illustrated in the accompanying drawings, in which like reference characters refer to the same parts throughout the different views.

FIG. 1a is a block diagram of an exemplary storage environment, in which techniques can be practiced for dynamically changing groups of central processing unit (CPU) cores (“cores”) for polling shared receive queues (SRQs), providing a tradeoff between decreasing latency and increasing throughput of storage nodes using remote procedure call (RPC) messaging;

FIG. 1b is a block diagram of a plurality of exemplary storage nodes using RPC messaging within the storage environment of FIG. 1a;

FIG. 2 is a block diagram illustrating fixed groups of cores and associated SRQs, which can be implemented in the plurality of storage nodes of FIG. 1b;

FIGS. 3a and 3b are block diagrams illustrating dynamically changing groups of cores and associated SRQs, which can be implemented in the plurality of storage nodes of FIG. 1b;

FIGS. 3c and 3d are additional block diagrams illustrating dynamically changing groups of cores and associated SRQs, which can be implemented in the plurality of storage nodes of FIG. 1b; and

FIG. 4 is a flow diagram of an exemplary method of dynamically changing groups of cores for polling SRQs in storage nodes using RPC messaging.

### DETAILED DESCRIPTION

Techniques are disclosed herein for dynamically changing groups of central processing unit (CPU) cores (“cores”) for polling shared receive queues (SRQs), providing a tradeoff between decreasing latency and increasing throughput of storage nodes using remote procedure call (RPC) messaging. The disclosed techniques can include, in response to initialization of a storage node (e.g., when its system load is low), assigning all cores of its multi-core CPU to the same single core group, decreasing latency. The disclosed techniques can include, in response to detecting that the system load has increased and been maintained above a threshold value for a predetermined time interval, increasing a number of core groups by a predetermined factor (e.g., 2), and decreasing a number of cores assigned to each core group by the predetermined factor (e.g., 2), increasing throughput. The disclosed techniques can include, in response to detecting that the system load has decreased and been maintained below the threshold value for the predetermined time interval, decreasing the number of core groups by the predetermined factor (e.g., 2), and increasing the number of cores assigned to each core group by the predetermined factor (e.g., 2). By dynamically changing, in runtime, the number of core groups and the number of cores assigned to each core group based on system runtime load statistics (e.g., IO load, IO pattern, usage pattern), an optimal tradeoff between decreasing latency and increasing throughput (as the number of cores available to poll each SRQ is increased/decreased) can be achieved.

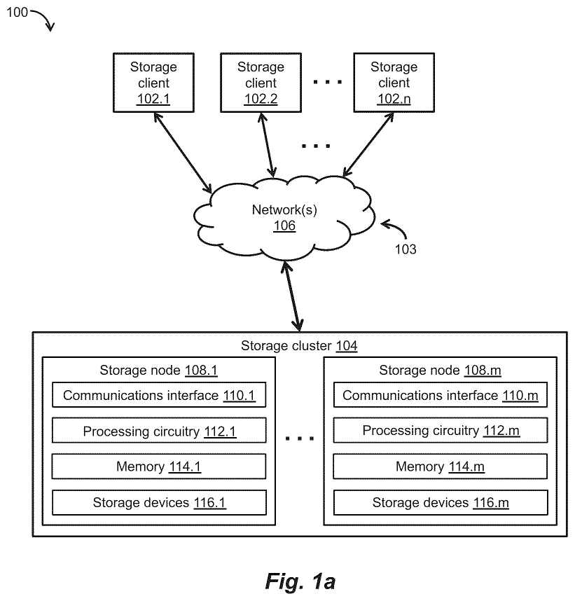

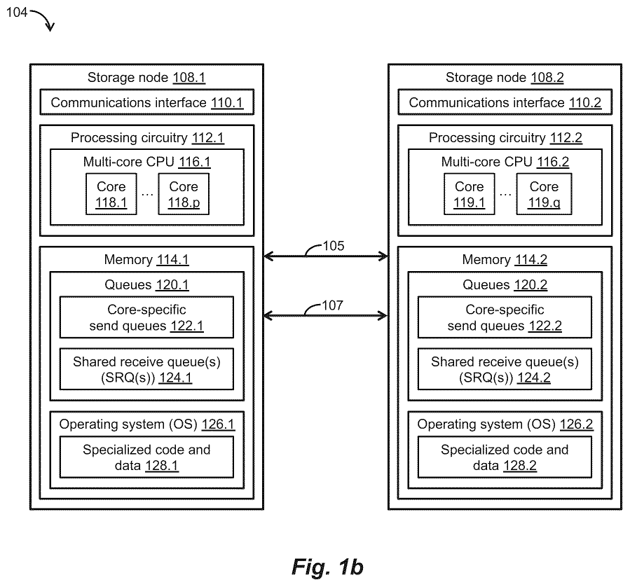

FIG. 1a depicts an illustrative embodiment of an exemplary storage environment 100 for dynamically changing groups of cores for polling shared receive queues (SRQs) in storage nodes using remote procedure call (RPC) messaging. As shown in FIG. 1a, the storage environment 100 can include a plurality of storage client computers (“storage clients”) 102.1, 102.2, . . . , 102.n, a storage cluster 104, and a communications medium 103 including at least one network 106. Each storage client 102.1, . . . , or 102.n can provide, over the network(s) 106, storage input/output (IO) requests (e.g., small computer system interface (SCSI) commands, network file system (NFS) commands) to storage nodes 108.1, . . . , 108.m (m=1, 2, 3, and so on) of the storage cluster 104. Such storage IO requests (e.g., write IO requests, read IO requests) can direct the storage nodes 108.1, . . . , 108.m to write and/or read data blocks, data pages, data files, or any other suitable data elements to/from logical units (LUs), volumes (VOLs), virtual volumes (VVOLs) (e.g., VMware® VVOLs), filesystems, or any other suitable storage objects, which can be maintained on storage devices (e.g., solid state drives (SSDs), hard disk drives (HDDs)) 116.1, . . . , 116.m associated with the respective storage nodes 108.1, . . . , 108.m.

The communications medium 103 can be configured to interconnect the plurality of storage clients 102.1, . . . , 102.n with the storage nodes 108.1, . . . , 108.m of the storage cluster 104 to enable them to communicate and exchange data and/or control signaling. As shown in FIG. 1a, the communications medium 103 can be illustrated as a “cloud” to represent different network topologies, such as a storage area network (SAN) topology, a network attached storage (NAS) topology, a local area network (LAN) topology, a metropolitan area network (MAN) topology, a wide area network (WAN) topology, and so on. As such, the communications medium 103 can include copper-based communications devices and cabling, fiber optic devices and cabling, wireless devices, and so on, or any suitable combination thereof.

Each storage node 108.1, . . . , or 108.m can have a communications interface, processing circuitry, memory, and associated storage devices. As shown in FIG. 1a, the storage node 108.1 can have a communications interface 110.1, processing circuitry 112.1, memory 114.1, and associated storage devices 116.1. Likewise, the storage node 108.m can have a communications interface 110.m, processing circuitry 112.m, memory 114.m, and associated storage devices 116.m. Each communications interface 110.1, . . . , or 110.m can include an RPC interface, Ethernet interface, InfiniBand interface, fiber channel (FC) interface, and/or any other suitable interface. Each communications interface 110.1, . . . , or 110.m can further include a SCSI target adapter, network interface adapter, and/or any other suitable communications adapter for converting electronic, optical, or wireless signals received over the network(s) 106 to a form suitable for use by the processing circuitries 112.1, . . . , 112.m. In some embodiments, the communications interfaces 110.1, . . . , 110.m can support a remote direct memory access (RDMA) over InfiniBand standard, RDMA over IP (iWARP) standard, RDMA over converged Ethernet (RoCE) standard, and/or nonvolatile memory express over fabrics (NVMe-oF) protocol. The memories 114.1, . . . , 114.m can include random access memory (RAM) or any other suitable volatile/nonpersistent memory, and nonvolatile RAM (NVRAM) or any other suitable nonvolatile/persistent memory. The processing circuitries 112.1, . . . , 112.m (e.g., central processing units (CPUs)) can be implemented as multi-core CPUs including sets of cores configured to execute specialized application threads, code, modules, and/or logic as program instructions out of the memories 114.1, . . . , 114.m. The processing circuitries 112.1, . . . , 112.m can process storage IO requests (e.g., write IO requests, read IO requests) issued by the storage clients 102.1, . . . , 102.n, and store data (or metadata) in the storage devices 116.1, . . . , 116.m within the storage environment 100, which can be a RAID (Redundant Array of Independent Disks) environment.

FIG. 1b depicts the storage node 108.1 and a storage node 108.2, each of which can be implemented in the storage cluster 104 of FIG. 1a. As shown in FIG. 1b, the storage node 108.1 can include the communications interface 110.1, the processing circuitry 112.1, and the memory 114.1. The processing circuitry 112.1 can include a multi-core CPU 116.1 that has a set of cores 118.1, . . . , 118.p. The memory 114.1 can implement a plurality of queues (e.g., first in, first out (FIFO) queues) 120.1, which can include multiple core-specific send queues 122.1, and one or more allocatable/de-allocatable SRQs 124.1. The memory 114.1 can accommodate an operating system (OS) 126.1, such as a Linux OS, Unix OS, Windows OS, or any other suitable OS, as well as specialized software code and data 128.1 for implementing the techniques disclosed herein. Likewise, the storage node 108.2 can include a communications interface 110.2, processing circuitry 112.2, and memory 114.2. The processing circuitry 112.2 can include a multi-core CPU 116.2 that has a set of cores 119.1, . . . , 119.q. The memory 114.2 can implement a plurality of queues (e.g., FIFO queues) 120.2, which can include multiple core-specific send queues 122.2, and one or more allocatable/de-allocatable SRQs 124.2. The memory 114.2 can accommodate an OS 126.2, such as a Linux OS, Unix OS, Windows OS, or any other suitable OS, as well as specialized software code and data 128.2 for implementing the techniques disclosed herein.

In the disclosed techniques, each storage node 108.1, . . . , or 108.m can communicate with other storage nodes of the storage cluster 104 using an RPC messaging protocol, or any other suitable protocol. One of ordinary skill in the art will appreciate that RPC messaging includes a protocol that a first computer program on a first computer can use to send, over a network, a service request to a second computer program on a second computer, without having to understand details of the network. For example, RPC messaging may be used by the storage nodes 108.1, 108.2 in a data buffering process, which may include receiving, over a network path 105 (see FIG. 1b), an RPC request message (“RPC request”) to buffer data (or metadata), sending, over the network path 105, a target memory address via an RPC reply message (“RPC reply”), and receiving, over a network path 107 (see FIG. 1b), the data (or metadata) to be buffered at the target memory address via an RDMA command. The storage node 108.1 can periodically poll its SRQ(s) 124.1 for receipt of the RPC request from the storage node 108.2, process the RPC request (and update metadata, as needed), generate the RPC reply, and send the RPC reply to the storage node 108.2, which can periodically poll its SRQs 124.2 for receipt of the RPC reply. For example, the storage node 108.1 and the storage node 108.2 may periodically poll their SRQ(s) 124.1 and SRQ(s) 124.2, respectively, for receipt of RPC requests/replies.

During operation, each storage node 108.1, . . . , or 108.m of the storage cluster 104 can dynamically change groups of CPU cores for polling SRQs, providing a tradeoff between decreasing latency and increasing throughput when using the RPC messaging protocol, or any other suitable protocol. Each storage node 108.1, . . . , or 108.m can assign each core of its multi-core CPU to a respective core group, and allocate a shared receive queue (SRQ) for the respective core group. Each SRQ can be configured to receive one or more RPC requests/replies generated in the course of RPC messaging. In one embodiment, each storage node 108.1, . . . , or 108.m can include a multi-core CPU, in which some of its cores (“poller cores”) are configured to execute dedicated core-specific polling threads, making the poller cores highly available to poll SRQs for RPC requests/replies. In this embodiment, the storage node 108.1, . . . , or 108.m can implement a fixed number of core groups equal to the number of poller cores of the multi-core CPU, and assign cores of the multi-core CPU to the core groups such that each core group includes one of the poller cores. Because each core group is provided with a poller core that is highly available for polling an SRQ, delays in processing RPC requests/replies can be reduced, decreasing latency.

In another embodiment, each storage node 108.1, . . . , or 108.m can dynamically change a number of core groups, as well as a number of cores assigned to each core group, based on updatable threshold values of the storage node's system load. In this embodiment, upon initialization (e.g., when the system load is low), the storage node 108.1, . . . , or 108.m can assign all cores of its multi-core CPU to the same single core group. In response to detecting that the system load has increased and been maintained above a threshold value for a predetermined time interval, the storage node 108.1, . . . , or 108.m can increase the number of core groups by a predetermined factor (e.g., 2), and decrease the number of cores assigned to each core group by the predetermined factor (e.g., 2). In response to detecting that the system load has decreased and been maintained below the threshold value for the predetermined time interval, the storage node 108.1, . . . , or 108.m can decrease the number of core groups by the predetermined factor (e.g., 2), and increase the number of cores assigned to each core group by the predetermined factor (e.g., 2). The predetermined time interval can provide hysteresis to prevent the storage node 108.1, . . . , or 108.m from increasing/decreasing the number of core groups and the number of cores assigned to each core group too frequently for only limited benefit. It is noted that the updatable threshold values and predetermined time interval can be determined through a series of performance test runs for different IO loads, IO patterns, usage patterns, and so on. In addition, the threshold values and time interval values can be dynamically adjusted during runtime. By dynamically changing, in runtime, the number of core groups and the number of cores assigned to each core group based on system runtime load statistics, an optimal tradeoff between decreasing latency and increasing throughput (as the number of cores available to poll a shared receive queue is increased/decreased) can be achieved.

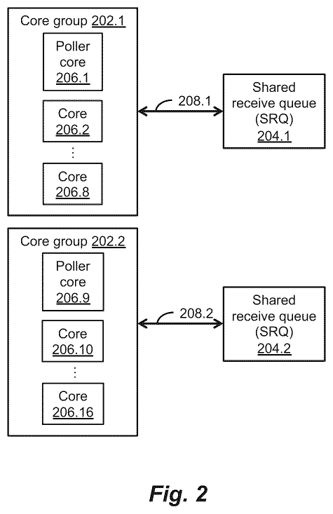

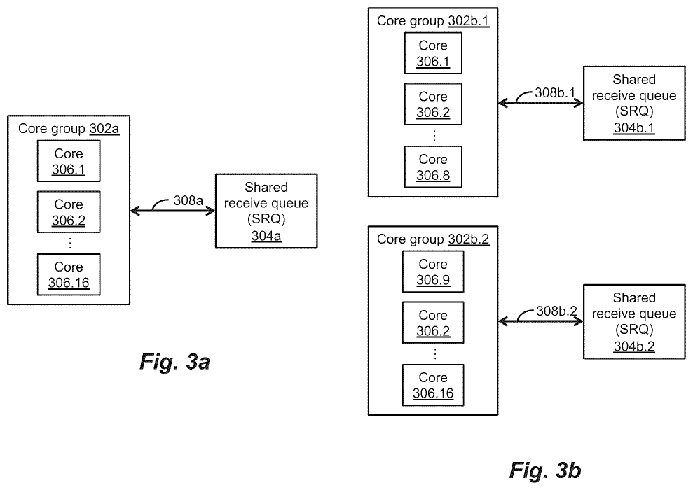

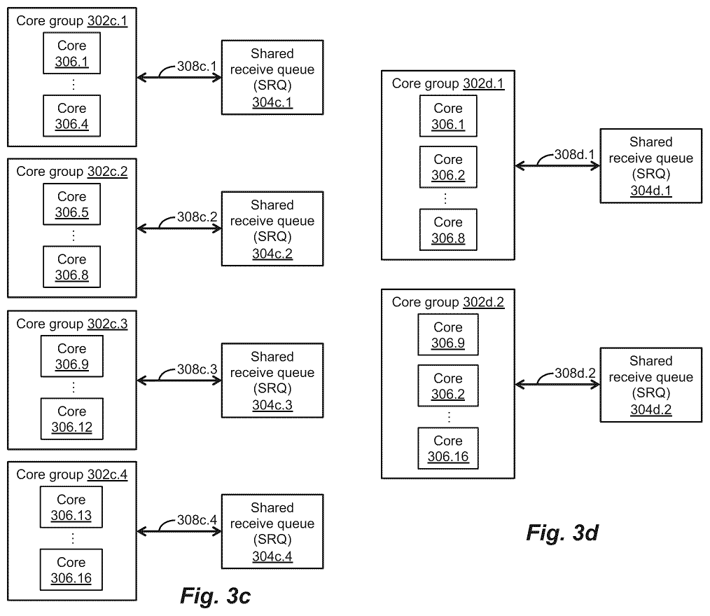

The disclosed techniques for dynamically changing groups of cores for polling SRQs in storage nodes using RPC messaging will be further understood with reference to the following illustrative examples, and FIGS. 2 and 3a-3d. In a first example, a case is considered where a storage node of the storage cluster 104 implements a fixed number of core groups for polling SRQs, each of which can receive RPC requests/replies during RPC messaging with another storage node of the storage cluster 104. In this first example, it is assumed that the storage node includes processing circuitry implemented as a multi-core CPU with sixteen (16) cores, namely, cores 206.1, 206.2, . . . , 206.16 (see FIG. 2). It is further assumed that two (2) of the sixteen (16) cores, namely, the core 206.1 and the core 206.9, have the role or function of poller cores, which are highly available to poll SRQs for RPC requests/replies. For example, the role or function of the two (2) poller cores 206.1, 206.9 may be predefined by the storage node.

FIG. 2 depicts the sixteen (16) cores 206.1, 206.2, . . . , 206.16 of the multi-core CPU, in which the roles or functions of the cores 206.1, 206.9 are predefined as poller cores. In this first example, because the sixteen (16) cores 206.1, 206.2, . . . , 206.16 include the two (2) poller cores 206.1, 206.9, the storage node implements a fixed number of core groups equal to the number of poller cores, namely, two (2) core groups 202.1, 202.2. Further, the storage node configures the core groups 202.1, 202.2 to include the same number of cores. In this first example, the core group 202.1 includes the eight (8) cores 206.1, 206.2, . . . , 206.8, and the core group 202.2 includes the same number (i.e., 8) of cores 206.9, 206.10, . . . , 206.16. Having implemented the fixed number of core groups with the same number of cores, the storage node allocates an SRQ for each core group. As shown in FIG. 2, an SRQ 204.1 is allocated for the core group 202.1, and an SRQ 204.2 is allocated for the core group 202.2.

In this first example, the storage node receives multiple RPC requests/replies during RPC messaging with the other storage node of the storage cluster 104. For example, the multiple RPC requests/replies may be sent to the storage node by cores of the other storage node using its core-specific send queues. The storage node distributes the RPC requests/replies across the SRQs 204.1, 204.2, allowing the RPC requests/replies to be polled and processed by the cores included in the respective core groups 202.1, 202.2. Once the RPC requests/replies have been distributed across the SRQs 204.1, 204.2, the core groups 202.1, 202.2 poll the SRQs 204.1, 204.2, respectively. In this first example, the cores 206.1, 206.2, . . . , 206.8 of the core group 202.1 poll, over a path 208.1, the SRQ 204.1 for RPC requests/replies when they have free processing cycles, and the first core to poll the SRQ 204.1 is assigned to process an RPC request/reply from the SRQ 204.1 (e.g., FIFO queue), as well as update metadata, as needed. Likewise, the cores 206.9, 206.10, . . . , 206.16 of the core group 202.2 poll, over a path 208.2, the SRQ 204.2 for RPC requests/replies when they have free processing cycles, and the first core to poll the SRQ 204.2 is assigned to process an RPC request/reply from the SRQ 204.2 (e.g., FIFO queue), as well as update metadata, as needed. Because the core groups 202.1, 202.2 are provided with the respective poller cores 206.1, 206.9, which are highly available for polling the SRQs 204.1, 204.2, delays in processing RPC requests/replies can be reduced, decreasing latency.

In a second example, a case is considered where a storage node of the storage cluster 104 implements a dynamically changing number of core groups for polling SRQs, as well as a dynamically changing number of cores assigned to each core group, based on updatable threshold values of the storage node's system load. In this second example, it is again assumed that the storage node includes processing circuitry implemented as a multi-core CPU with sixteen (16) cores, namely, cores 306.1, 306.2, . . . , 306.16 (see FIG. 3).

FIG. 3a depicts the sixteen (16) cores 306.1, 306.2, . . . , 306.16 of the multi-core CPU. In this second example, upon initialization (e.g., when the system load is low), the storage node assigns all the cores 306.1, 306.2, . . . , 306.16 of its multi-core CPU to the same single core group 302a, and allocates an SRQ 304a for the core group 302a. Further, the storage node receives multiple RPC requests/replies during RPC messaging with another storage node of the storage cluster 104. For example, the multiple RPC requests/replies may be sent to the storage node by cores of the other storage node using its core-specific send queues, and queued in the SRQ 304a. The cores 306.1, 306.2, . . . , 306.16 of the core group 302a poll, over a path 308a, the SRQ 304a for RPC requests/replies when they have free processing cycles, and the first core to poll the SRQ 304a is assigned to process an RPC request/reply from the SRQ 304a (e.g., FIFO queue), as well as update metadata, as needed.

FIG. 3b again depicts the sixteen (16) cores 306.1, . . . , 306.16 of the multi-core CPU. In response to monitoring and detecting that the system load has increased and been maintained above a first threshold value for a predetermined time interval, the storage node increases the number of core groups by a predetermined factor (e.g., 2), decreases the number of cores assigned to each core group by the predetermined factor (e.g., 2), and updates the threshold value from the first threshold value to a second threshold value. For example, each such threshold value may be updated (e.g., increased/decreased) by a power of two (2), or any other suitable increment or amount. In this example, the storage node increases the number of core groups from one (1) core group (i.e., the core group 302a; see FIG. 3a) to two (2) core groups (i.e., core group 302b.1, core group 302.b2; see FIG. 3b). Further, the storage node decreases the number of cores assigned to each core group from sixteen (16) cores (i.e., cores 306.1-306.16 assigned to core group 302a; see FIG. 3a) to eight (8) cores (i.e., cores 306.1-306.8 assigned to core group 302b.1, cores 306.9-306.16 assigned to core group 302b.2; see FIG. 3b).

Having assigned the cores 306.1-306.8 and the cores 306.9-306.16 to the core group 302b.1 and the core group 302b.2, respectively, the storage node de-allocates the SRQ 304a (see FIG. 3a), and allocates an SRQ 304b.1 and an SRQ 304b.2 for the core group 302b.1 and the core group 302b.2, respectively. Further, the storage node receives multiple RPC requests/replies during RPC messaging with the other storage node of the storage cluster 104, and distributes the RPC requests/replies across the SRQs 304b.1, 304b.2. The cores 306.1, . . . , 306.8 of the core group 302b.1 poll, over a path 308b.1, the SRQ 304b.1 for RPC requests/replies when they have free processing cycles, and the first core to poll the SRQ 304b.1 is assigned to process an RPC request/reply from the SRQ 304b.1 (e.g., FIFO queue), as well as update metadata, as needed. Likewise, the cores 306.9, . . . , 306.16 of the core group 302b.2 poll, over a path 308b.2, the SRQ 304b.2 for RPC requests/replies when they have free processing cycles, and the first core to poll the SRQ 304b.2 is assigned to process an RPC request/reply from the SRQ 304b.2 (e.g., FIFO queue), as well as update metadata, as needed.

FIG. 3c again depicts the sixteen (16) cores 306.1, . . . , 306.16 of the multi-core CPU. In response to monitoring and detecting that the system load has increased and been maintained above the second threshold value for the predetermined time interval, the storage node increases the number of core groups by the predetermined factor (e.g., 2), decreases the number of cores assigned to each core group by the predetermined factor (e.g., 2), and updates the threshold value from the second threshold value to a third threshold value. In this example, the storage node increases the number of core groups from two (2) core groups (i.e., core group 302b.1, core group 302b.2; see FIG. 3b) to four (4) core groups (i.e., core group 302c.1, core group 302c.2, core group 302c.3, core group 302c.4; see FIG. 3c). Further, the storage node decreases the number of cores assigned to each core group from eight (8) cores (i.e., cores 306.1-306.8 assigned to core group 302b.1, cores 306.9-306.16 assigned to core group 302b.2; see FIG. 3b) to four (4) cores (i.e., cores 306.1-306.4 assigned to core group 302c.1, cores 306.5-306.8 assigned to core group 302c.2, cores 306.9-306.12 assigned to core group 302c.3, cores 306.13-306.16 assigned to core group 302c.4; see FIG. 3c).

Having assigned the cores 306.1-306.4, the cores 306.5-306.8, the cores 306.9-306.12, and the cores 306.13-306.16 to the core group 302c.1, the core group 302c.2, the core group 302c.3, and the core group 302c.4, respectively, the storage node de-allocates the SRQs 304b.1, 304b.2 (see FIG. 3b), and allocates an SRQ 304c.1, an SRQ 304c.2, an SRQ 304c.3, and an SRQ 304c.4 for the core group 302c.1, the core group 302c.2, the core group 302c.3, and the core group 302c.4, respectively. Further, the storage node receives multiple RPC requests/replies during RPC messaging with the other storage node of the storage cluster 104, and distributes the RPC requests/replies across the SRQs 304c.1-304c.4. The cores 306.1-306.4 of the core group 302c.1 poll, over a path 308c.1, the SRQ 304c.1 for RPC requests/replies when they have free processing cycles, and the cores 306.5-306.8 of the core group 302c.2 poll, over a path 308c.2, the SRQ 304c.2 for RPC requests/replies when they have free processing cycles. Likewise, the cores 306.9-306.12 of the core group 302c.3 poll, over a path 308c.3, the SRQ 304c.3 for RPC requests/replies when they have free processing cycles, and the cores 306.13-306.16 of the core group 302c.4 poll, over a path 308c.4, the SRQ 304c.4 for RPC requests/replies when they have free processing cycles. The first cores to poll the SRQs 304c.1-304c.4 are assigned to process RPC requests/replies from the respective SRQs 304c.1-304c.4 (e.g., FIFO queues), as well as update metadata, as needed.

FIG. 3d again depicts the sixteen (16) cores 306.1, . . . , 306.16 of the multi-core CPU. In response to monitoring and detecting that the system load has decreased and been maintained below the third threshold value for the predetermined time interval, the storage node decreases the number of core groups by the predetermined factor (e.g., 2), and increases the number of cores assigned to each core group by the predetermined factor (e.g., 2). In this example, the storage node decreases the number of core groups from four (4) core groups (i.e., core group 302c.1, core group 302c.2, core group 302c.3, core group 302c.4; see FIG. 3c) to two (2) core groups (i.e., core group 302d.1, core group 302d.2; see FIG. 3d). Further, the storage node increases the number of cores assigned to each core group from four (4) cores (i.e., cores 306.1-306.4 assigned to core group 302c.1, cores 306.5-306.8 assigned to core group 302c.2, cores 306.9-306.12 assigned to core group 302c.3, cores 306.13-306.16 assigned to core group 302c.4; see FIG. 3c) to eight (8) cores (i.e., cores 306.1-306.8 assigned to core group 302d.1, cores 306.9-306.16 assigned to core group 302d.2; see FIG. 3d).

Having assigned the cores 306.1-306.8 and the cores 306.9-306.16 to the core group 302d.1 and the core group 302d.2, respectively, the storage node de-allocates the SRQs 304c.1-304c.4 (see FIG. 3c), and allocates an SRQ 304d.1 and an SRQ 304d.2 for the core group 302d.1 and the core group 302d.2, respectively. Further, the storage node receives multiple RPC requests/replies during RPC messaging with the other storage node of the storage cluster 104, and distributes the RPC requests/replies across the SRQs 304d.1, 304d.2. The cores 306.1-306.8 of the core group 302d.1 poll, over a path 308d.1, the SRQ 304d.1 for RPC requests/replies when they have free processing cycles, and the cores 306.9-306.16 of the core group 302d.2 poll, over a path 308d.2, the SRQ 304d.2 for RPC requests/replies when they have free processing cycles. The first cores to poll the SRQs 304d.1, 304d.2 are assigned to process RPC requests/replies from the respective SRQs 304d.1, 304d.2 (e.g., FIFO queues), as well as update metadata, as needed. By dynamically changing the number of core groups and the number of cores assigned to each core group based on the updatable threshold values of the system load, an optimal tradeoff between decreasing latency and increasing throughput (as the number of cores available to poll an SRQ is increased/decreased) can be achieved.

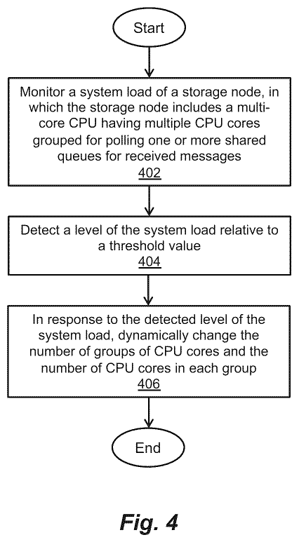

A method of dynamically changing groups of CPU cores for polling shared receive queues, providing a tradeoff between decreasing latency and increasing throughput of storage nodes using RPC messaging, is described below with reference to FIG. 4. As depicted in block 402, a system load of a storage node is monitored, in which the storage node includes a multi-core CPU having multiple CPU cores grouped for polling one or more shared queues for received messages. As depicted in block 404, a level of the system load is detected relative to a threshold value. As depicted in block 406, in response to the detected level of the system load, the number of groups of CPU cores and the number of CPU cores in each group are dynamically changed.

Having described the above illustrative embodiments, various alternative embodiments and/or variations may be made and/or practiced. For example, it was described herein that storage nodes of the storage cluster 104 can distribute RPC requests/replies across multiple SRQs, allowing the RPC requests/replies to be polled and processed by respective groups of CPU cores. In one embodiment, such requests, replies, or commands can be distributed across multiple SRQs based on available processing cycles of CPU cores, a fullness of each SRQ, receive-side scaling (RSS) technology, and/or any other suitable criteria or technology. In one embodiment, the storage nodes can use locks, spinlocks, or any other suitable synchronization mechanism(s) to manage or restrict access to shared queues, shared data structures, or other shared resources within the storage environment 100.

It was further described herein that storage nodes of the storage cluster 104 can periodically poll SRQs for receipt of RPC requests, process the RPC requests (and update metadata, as needed), generate RPC replies, and send the RPC replies to other storage nodes, which can periodically poll their SRQs for receipt of the RPC replies. In one embodiment, storage nodes of the storage cluster 104 can periodically poll shared completion queues (SCQs), each of which can be associated or paired with a respective SRQ and configured to report completed receipt of requests/replies/commands at the respective SRQ.

It was further described herein that storage nodes of the storage cluster 104 can dynamically change a number of core groups, as well as a number of CPU cores assigned to each core group, based on updatable threshold values of the storage node's system load. In one embodiment, such updatable threshold values can range from a low threshold value to a high threshold value, with zero (0), one (1), or more intermediate threshold values between the low threshold value and the high threshold value.

It was further described herein that storage nodes of the storage cluster 104 can increase/decrease a number of core groups by a predetermined factor, and decrease/increase a number of CPU cores assigned to each core group by the predetermined factor, in response to detecting that a system load has been maintained at a level relative to an updatable threshold value for a predetermined time interval, thereby providing hysteresis. In one embodiment, such hysteresis can be provided using a threshold crossing window or time value. In one embodiment, a system load can be allowed to increase/decrease past two (2) or more updatable threshold values before dynamically changing the number of core groups and the number of CPU cores assigned to each core group, thereby avoiding assigning/reassigning CPU cores to respective core groups too frequently for only limited benefit.

It was further described herein that storage nodes of the storage cluster 104 can assign each CPU core of their multi-core CPUs to a respective core group, and allocate an SRQ for the respective core group. In one embodiment, storage nodes can enforce a policy that requires each core group be assigned at least two (2) CPU cores. In one embodiment, storage nodes can assign CPU cores that share a level (e.g., lower level cache (LLC)) of a multi-level cache memory to the same core group. In one embodiment, storage nodes can assign CPU cores that execute similar application threads to the same core group for more efficient cache memory utilization. In one embodiment, storage nodes (“NUMA nodes”) can implement a non-uniform memory access (NUMA) architecture, and assign CPU cores that utilize resources (e.g., communications adapters) local to the NUMA nodes to the same core group. In one embodiment, storage nodes can wait until all in-flight RPC requests/replies or other in-flight requests/replies/commands are completed before assigning/reassigning CPU cores to respective core groups.

It was further described herein that storage nodes of the storage cluster 104 can include a multi-core CPU, in which some of its CPU cores (“poller cores”) are configured to execute dedicated core-specific polling threads, making the poller cores highly available to poll SRQs for RPC requests/replies. In one embodiment, storage nodes can monitor an average queue polling frequency of each CPU core, and enforce a policy that requires each core group to contain at least one CPU core with a high (or highest) average queue polling frequency, thereby decreasing latency. It is noted that CPU core frequency can change dynamically during runtime. In one embodiment, storage nodes can monitor CPU cores that are highly stressed in responding to RPC requests or other requests/commands, and enforce a policy that requires each core group containing at least one high-stressed (i.e., high latency) CPU core to contain at least one low-stressed (i.e., low latency) CPU core.

Several definitions of terms are provided below for the purpose of aiding the understanding of the foregoing description, as well as the claims set forth herein.

As employed herein, the term “storage system” is intended to be broadly construed to encompass, for example, private or public cloud computing systems for storing data, as well as systems for storing data comprising virtual infrastructure and those not comprising virtual infrastructure.

As employed herein, the terms “client,” “host,” and “user” refer, interchangeably, to any person, system, or other entity that uses a storage system to read/write data.

As employed herein, the term “storage device” may refer to a storage array including multiple storage devices. Such a storage device may refer to any non-volatile memory (NVM) device, including hard disk drives (HDDs), solid state drives (SSDs), flash devices (e.g., NAND flash devices, NOR flash devices), and/or similar devices that may be accessed locally and/or remotely, such as via a storage area network (SAN).

As employed herein, the term “storage array” may refer to a storage system used for block-based, file-based, or other object-based storage. Such a storage array may include, for example, dedicated storage hardware containing HDDs, SSDs, and/or all-flash drives.

As employed herein, the term “storage entity” may refer to a filesystem, an object storage, a virtualized device, a logical unit (LU), a logical volume (LV), a logical device, a physical device, and/or a storage medium.

As employed herein, the term “logical unit” may refer to a logical entity provided by a storage system for accessing data from the storage system and may be used interchangeably with the term “logical volume” (LV). The term “logical unit” may also refer to a logical unit number (LUN) for identifying a logical unit, a virtual disk, or a virtual LUN.

As employed herein, the term “physical storage unit” may refer to a physical entity such as a storage drive or disk or an array of storage drives or disks for storing data in storage locations accessible at addresses. The term “physical storage unit” may be used interchangeably with the term “physical volume.”

As employed herein, the term “storage medium” may refer to a hard drive or flash storage, a combination of hard drives and flash storage, a combination of hard drives, flash storage, and other storage drives or devices, or any other suitable types and/or combinations of computer readable storage media. Such a storage medium may include physical and logical storage media, multiple levels of virtual-to-physical mappings, and/or disk images. The term “storage medium” may also refer to a computer-readable program medium.

As employed herein, the term “IO request” may refer to a data input request or a data output request such as a read request or a write request.

As employed herein, the terms, “such as,” “for example,” “e.g.,” “exemplary,” and variants thereof refer to non-limiting embodiments and have meanings of serving as examples, instances, or illustrations. Any embodiments described herein using such phrases and/or variants are not necessarily to be construed as preferred or more advantageous over other embodiments, and/or to exclude incorporation of features from other embodiments.

As employed herein, the term “optionally” has a meaning that a feature, element, process, etc., may be provided in certain embodiments and may not be provided in certain other embodiments. Any particular embodiment of the present disclosure may include a plurality of optional features unless such features conflict with one another.

While various embodiments of the present disclosure have been particularly shown and described, it will be understood by those skilled in the art that various changes in form and/or details may be made therein without departing from the scope of the present disclosure, as defined by the appended claims.

What is claimed is:

1. A method comprising:
monitoring a system load of a storage node, the storage node including a multi-core central processing unit (CPU) having multiple CPU cores grouped for polling at least one shared queue for received messages;
detecting a level of the system load relative to a threshold value; and
in response to the detected level of the system load:
dynamically changing a number of groups of CPU cores, and
dynamically changing a number of CPU cores in each group.

2. The method of claim 1 comprising:
upon initialization of the storage node, assigning all the CPU cores to a single group;
allocating a single shared queue for the single group; and
polling, by the CPU cores assigned to the single group, the single shared queue for received messages.

3. The method of claim 2 wherein detecting the level of the system load includes detecting that the system load has increased relative to the threshold value, wherein dynamically changing the number of groups includes increasing the number of groups by a predetermined factor, and wherein dynamically changing the number of CPU cores in each group includes decreasing the number of CPU cores in each group by the predetermined factor.

4. The method of claim 3 comprising:
assigning the decreased number of CPU cores to each of the increased number of groups;
allocating a plurality of shared queues for the increased number of groups, respectively; and
polling the plurality of shared queues for received messages by the decreased number of CPU cores assigned to the increased number of groups, respectively.

5. The method of claim 3 wherein detecting the level of the system load includes detecting that the system load has decreased relative to the threshold value, wherein dynamically changing the number of groups includes decreasing the number of groups by the predetermined factor, and wherein dynamically changing the number of CPU cores in each group includes increasing the number of CPU cores in each group by the predetermined factor.

6. The method of claim 5 comprising:
assigning the increased number of CPU cores to each of the decreased number of groups;
allocating a decreased plurality of shared queues for the decreased number of groups, respectively; and
polling the decreased plurality of shared queues for received messages by the increased number of CPU cores assigned to the decreased number of groups, respectively.

7. The method of claim 1 comprising:
performing one or more of:
assigning CPU cores that share a cache level to the same group;
assigning CPU cores that execute similar application threads to the same group;
assigning CPU cores that utilize resources local to a NUMA (non-uniform memory access) node to the same group;
assigning a CPU core with a high average queue polling frequency to each group; and
assigning a low-stressed CPU core to each group including a high-stressed CPU core.

8. The method of claim 1 wherein the multiple CPU cores are grouped for polling the at least one shared queue for received remote procedure call (RPC) messages, and wherein the method comprises:
polling, by the number of groups of CPU cores, the at least one shared queue for an RPC request message from another storage node;
processing the RPC request message;
generating an RPC reply message; and
sending the RPC reply message to the other storage node.

9. The method of claim 1 wherein detecting the level of the system load includes detecting that the system load has increased relative to the threshold value, wherein dynamically changing the number of groups includes increasing the number of groups by a predetermined factor, and wherein dynamically changing the number of CPU cores in each group includes decreasing the number of CPU cores in each group by the predetermined factor.

10. The method of claim 1 wherein detecting the level of the system load includes detecting that the system load has decreased relative to the threshold value, wherein dynamically changing the number of groups includes decreasing the number of groups by a predetermined factor, and wherein dynamically changing the number of CPU cores in each group includes increasing the number of CPU cores in each group by the predetermined factor.

11. A system comprising:
a memory; and
processing circuitry configured to execute program instructions out of the memory to:
monitor a system load of a storage node, the storage node including a multi-core central processing unit (CPU) having multiple CPU cores grouped for polling at least one shared queue for received messages;
detect a level of the system load relative to a threshold value; and
in response to the detected level of the system load:
dynamically change a number of groups of CPU cores, and
dynamically change a number of CPU cores in each group.

12. The system of claim 11 wherein the processing circuitry is configured to execute the program instructions out of the memory to:
upon initialization of the storage node, assign all the CPU cores to a single group;
allocate a single shared queue for the single group; and
poll, by the CPU cores assigned to the single group, the single shared queue for received messages.

13. The system of claim 12 wherein the processing circuitry is configured to execute the program instructions out of the memory to:
detect that the system load has increased relative to the threshold value;
increase the number of groups by a predetermined factor; and
decrease the number of CPU cores in each group by the predetermined factor.

14. The system of claim 13 wherein the processing circuitry is configured to execute the program instructions out of the memory to:
assign the decreased number of CPU cores to each of the increased number of groups;
allocate a plurality of shared queues for the increased number of groups, respectively; and
poll the plurality of shared queues for received messages by the decreased number of CPU cores assigned to the increased number of groups, respectively.

15. The system of claim 13 wherein the processing circuitry is configured to execute the program instructions out of the memory to:
detect that the system load has decreased relative to the threshold value;
decrease the number of groups by the predetermined factor; and
increase the number of CPU cores in each group by the predetermined factor.

16. The system of claim 15 wherein the processing circuitry is configured to execute the program instructions out of the memory to:
assign the increased number of CPU cores to each of the decreased number of groups;
allocate a decreased plurality of shared queues for the decreased number of groups, respectively; and
poll the decreased plurality of shared queues for received messages by the increased number of CPU cores assigned to the decreased number of groups, respectively.

17. The system of claim 11 wherein the multiple CPU cores are grouped for polling the at least one shared queue for received remote procedure call (RPC) messages, and wherein the processing circuitry is configured to execute the program instructions out of the memory to:
poll, by the number of groups of CPU cores, the at least one shared queue for an RPC request message from another storage node;
process the RPC request message;
generate an RPC reply message; and
send the RPC reply message to the other storage node.

18. A computer program product including a set of non-transitory, computer-readable media having instructions that, when executed by processing circuitry, cause the processing circuitry to perform a method comprising:
monitoring a system load of a storage node, the storage node including a multi-core central processing unit (CPU) having multiple CPU cores grouped for polling at least one shared queue for received messages;
detecting a level of the system load relative to a threshold value; and
in response to the detected level of the system load:
dynamically changing a number of groups of CPU cores, and
dynamically changing a number of CPU cores in each group.

19. The computer program product of claim 18 wherein detecting the level of the system load includes detecting that the system load has increased relative to the threshold value, wherein dynamically changing the number of groups includes increasing the number of groups by a predetermined factor, and wherein dynamically changing the number of CPU cores in each group includes decreasing the number of CPU cores in each group by the predetermined factor.

20. The computer program product of claim 18 wherein detecting the level of the system load includes detecting that the system load has decreased relative to the threshold value, wherein dynamically changing the number of groups includes decreasing the number of groups by a predetermined factor, and wherein dynamically changing the number of CPU cores in each group includes increasing the number of CPU cores in each group by the predetermined factor.
